(19) United States
(12) Patent Application Publication
(10) Pub. No.: US 2016/0179197 A1
(43) Pub. Date: Jun. 23, 2016

(54) METHOD AND SYSTEM FOR INTEGRATING SMART TV PROGRAM CHANNELS WITH APPLICATIONS

(71) Applicant: HUIZHOU TCL MOBILE COMMUNICATION CO., LTD., HUIZHOU (CN)

(72) Inventors: Wen Qian, HUIZHOU (CN); Zheng Yu, (US)

(21) Appl. No.: 14/770,367

(22) PCT Filed: May 30, 2014
(86) PCT No.: PCT/CN2014/078866

§ 371 Date: Aug. 25, 2015

(30) Foreign Application Priority Data
Mar. 19, 2014 (CN) 201410102151.8

(51) Int. Cl. G06F 3/01

(52) U.S. Cl. CPC G06F 3/015; G06F 3/017

(57) ABSTRACT

A method and a system for controlling operation modes of a mobile device may include a wearable device that acquires current vital sign data of a user, and transmits the current vital sign data to a mobile device. The mobile device may receive the vital sign data and may determine a current motion state of the user according to the vital sign data. The mobile device may acquire an operation mode corresponding to the current motion state of the user according to the current motion state of the user, and may switch the current operation mode of the mobile device to the corresponding operation mode. With the wearable device or accessories thereof, the state of a user may be determined intelligently, and a smart terminal may be controlled to enter a corresponding operation mode. The wearable device may achieve the function of intelligently controlling the operation mode switch like a remote control, making it more convenient for the user to use the device.

### TECHNICAL FIELD

The present disclosure relates to the field of wearable devices and mobile terminals. In particular, the present disclosure relates to a method and a system for controlling operation modes of a mobile device.

### BACKGROUND

Smart phones have increasingly powerful functions and more applications, and people are spending more time on their cell phones. Power consumption has become one of the biggest issues that smart phone users need to pay attention to. Although cell phone manufacturers have designed many power saving modes, most of the power saving modes designed by manufacturers or developers achieve more power saving from a software level. No solution close to use habits of users has been designed regarding when to turn on or off a power saving mode.

When switching cell phone operation modes, users of smart phones, that are currently available on the market, often make manual adjustments according to the environment in which the users are in. For example, a meeting mode may be selected during a meeting, a silent mode may be selected during rest or an outdoor mode may be selected during exercises. Alternatively, a gravity sensor, an acceleration sensor, a gyroscope or a heartbeat sensor may be provided on a smart phone to detect a current state of a user. Thereby, an operation mode of a cell phone may be intelligently adjusted. However, no technology that controls the operation mode of an intelligent terminal, through other devices, has been developed.

Therefore, the prior art is in need of improvement and development.

### SUMMARY

In light of the above drawbacks of the prior art, an object of the present invention is to provide a method and a system for controlling operation modes of a mobile device, which may overcome the drawback that operation modes of mobile devices can only be manually switched and/or the drawback of intelligent switch based on the state of a mobile device according to the prior art.

A method for controlling operation modes of a mobile device includes a wearable device acquires current vital sign data of a user, and transmits the current vital sign data to the mobile device; the mobile device receives the vital sign data and determines a current motion state of the user according to the vital sign data; the mobile device acquires an operation mode corresponding to the current motion state of the user according to the current motion state of the user, and switches a current operation mode of the mobile device to the corresponding operation mode.

In another embodiment, a method for controlling operation modes of a mobile device includes a mobile device that receives an operation command from a user and sets operation modes corresponding to a plurality of respective motion states of the user.

In a further embodiment, a method for controlling operation modes of a mobile device includes a wearable device that receives an operation command from a user and establishes connection with the mobile device; the wearable device acquires current vital sign data of the user with a sensor provided therein; the wearable device receives an operation command from the user and transmits the vital sign data to the mobile device.

In yet another embodiment, a method for controlling operation modes of a mobile device includes operation modes of the mobile device that comprise a power saving mode, a silent mode and a normal mode.

In yet another embodiment, a method for controlling operation modes of a mobile device includes a wearable device that establishes connection with the mobile device via any one of Bluetooth, IR, wifi and NFC.

In yet a further embodiment, a method for controlling operation modes of a mobile device includes a wearable device that is either a smart watch, a smart ring, smart glasses, smart shoes or smart clothing.

In another embodiment, a system for controlling operation modes of a mobile device includes a monitoring and transmitting module for a wearable device to acquire current vital sign data of a user and to transmit the current vital sign data to the mobile device; a receiving and determining module for the mobile device to receive the vital sign data and to determine a current motion state of the user according to the vital sign data; a mode switching module for the mobile device to acquire an operation mode corresponding to a current motion state of the user according to the current motion state of the user, and to switch a current operation mode of the mobile device to the corresponding operation mode.

In a further embodiment, a system for controlling operation modes of a mobile device includes a setting module for the mobile device to receive an operation command from a user and to set operation modes corresponding to a plurality of respective motion states of the user.

In yet another embodiment, a system for controlling operation modes of a mobile device includes a monitoring and transmitting module that comprises a connection unit for a wearable device to receive an operation command from a user and to establish connection with the mobile device; a state acquiring unit for the wearable device to acquire current vital sign data of the user with a sensor provided therein; a transmitting unit for the wearable device to receive an operation command from the user and to transmit the vital sign data to the mobile device.

In yet a further embodiment, a system for controlling operation modes of a mobile device includes a wearable device that is either a smart watch, a smart ring, smart glasses, smart shoes or smart clothing.

The present invention provides a method and a system for controlling operation modes of a mobile device that includes a wearable device that acquires current vital sign data of a user, and transmits the current vital sign data to a mobile device; the mobile device receives the vital sign data and determines a current motion state of the user according to the vital sign data; the mobile device acquires an operation mode corresponding to a current motion state of the user according to the current motion state of the user, and switches a current operation mode of the mobile device to the corresponding operation mode. With the wearable device or accessories thereof, a state of a user is determined intelligently, and a smart terminal is controlled to enter a corresponding operation mode. The wearable device achieves a function of intelligently controlling an operation mode switch similar to, for example, like a remote control, making it more convenient for the user to use the device.

### BRIEF DESCRIPTION OF THE DRAWINGS

FIG. 1 depicts a flow chart of an exemplary method for controlling operation modes of a mobile device according to the present invention;

FIG. 2 depicts a structural block diagram of an exemplary system for controlling operation modes of a mobile device according to the present invention.

### DETAILED DESCRIPTION

The present invention provides a method and a system for controlling operation modes of a mobile device. To make the object, technical solution and effect of the present invention clearer and more specific, the present invention will be further described in detail below. It should be understood that the specific embodiments herein are only used to describe the present invention, rather than to limit the present invention.

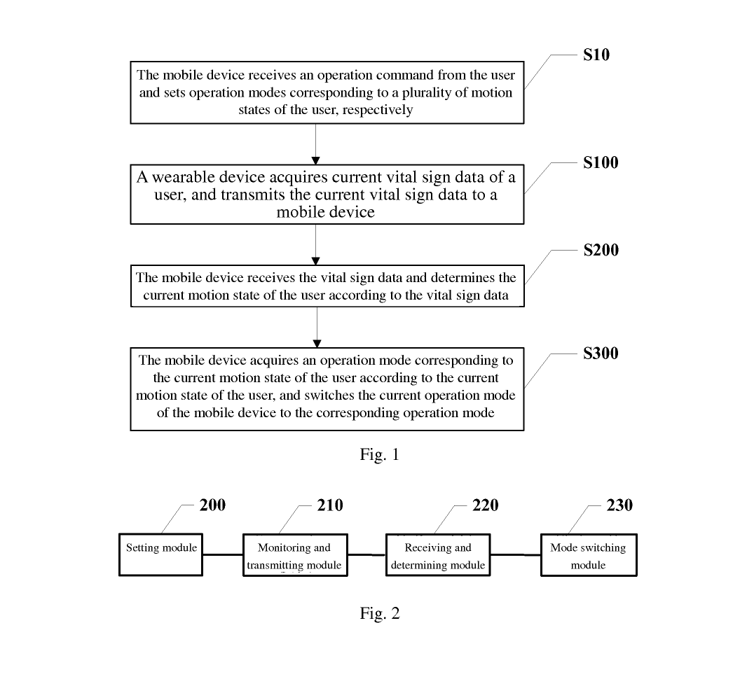

With reference to FIG. 1, a flow chart of an exemplary method for controlling operation modes of a mobile device may include a wearable device that may acquire current vital sign data of a user, and may transmit the current vital sign data to the mobile device (block S100). The vital sign data of a user may be collected in real time through a variety of sensors provided in the wearable device (block S100). The vital sign data may not be, in a strict sense, data of human organs collected via medical devices in the medical field, and may be, for example, a variety of data of human body, in a broader sense, collected via a variety of sensors. For example, the vital sign data may be collected using a variety of sensors to: recognize and record active time and/or rest time, exercise intensity, a number of steps, walking distance and/or calories burned by a user in an exercise state, to recognize and record slight wrist movements in states of light sleep and/or deep sleep, record time needed to fall asleep, balance between light sleep and deep sleep, time lying on a bed and times of wake-up during the night, etc. When the wearable device has acquired vital sign data of the user, the wearable device may transmit the acquired vital sign data to the mobile device. The mobile device may receive the vital sign data and may determine a current motion state of the user according to the vital sign data (block S200). When the mobile device receives the vital sign data, the mobile device may detect changes to the user behaviors together with the sensors in the mobile device (block S200). When the mobile device receives the vital sign data of the user transmitted by the wearable device, the mobile device may, for example, determine a current motion state of the user with reference to data in a human vital sign parameter database stored in the mobile device. The mobile device may acquire an operation mode corresponding to the current motion state of the user according to the current motion state of the user, and may switch a current operation mode of the mobile device to the corresponding operation mode (block S300).

When the mobile terminal acquires the current motion state of the user, the mobile device may issue a command to switch the current operation mode of the mobile device. For example, a current heartbeat of a user, collected by the wearable device may be 75 beats/minute. The heartbeat data may be transmitted to the mobile device. Since a table of correspondence between current state of the user and operation mode of the device may be provided in the mobile device, the data in the table may be compared with the current heartbeat data to determine, for example, that the operation mode of the mobile device corresponding to the current heartbeat should be a normal mode. Thus, the mobile device may be automatically switched to the normal mode. If the current heartbeat of a user, collected by the wearable device is 60 beats/minute, for example, the mobile device may be automatically switched to a silent mode. The current state of the user may be acquired via the wearable device, the mobile device may receive the data representative of the current state of the user, and may, for example, intelligently switch the operation mode of the mobile device based on the data representative of the current state of the user. Even if the mobile device is away from the user at a distance, the mobile device may control remotely the switch of operation modes of the mobile device, leading to great convenience for the user.

As further shown in FIG. 1, prior to the wearable device establishing connection with the mobile device (block S100), the mobile device may receive an operation command from the user, and may set operation modes corresponding to a plurality of respective motion states of the user (block S10). The operation modes corresponding to a plurality of respective motion states of the user (block S10) may be either set by a manufacturer before the mobile device is shipped or may be set by the user according to the vital sign parameters.

Furthermore, operation modes of the mobile device may include a power saving mode, a silent mode, and a normal mode. Besides the above three modes, or in addition to the above three modes, more modes may be further set to meet the actual use demand by mobile device users. For example, an operation mode of the mobile device may be altered by setting a meeting mode, an exercise mode, etc. A wearable device may establish connection with the mobile device when, for example, the wearable device receives an operation command from the user (block S101). The wearable device may establish connection with the mobile device via any one of: Bluetooth, IR, wifi and NFC. After the wearable device establishes connection with the mobile device, the wearable device and the mobile device can perform real time data exchange. The wearable device may acquire current vital sign data of the user with a sensor provided in the wearable device. A current state of the user may include: a waking state, a light sleep state, and/or a deep sleep state. A determination of the current state of a user may be based on a variety of sensors provided in the wearable device, such as an acceleration sensor, a heartbeat sensor, a gyroscope, and/or a gravity sensor, that collect parameters of a user, such as a current motion state, a heartbeat, a pulse, etc. A current state of the user may be determined in a comprehensive way according to the above parameters.

The wearable device may receive an operation command from the user and may transmit the vital sign data to the mobile device (block S103). When the wearable device transmits the current vital sign data to the mobile device (block S100), the transmission may be made regularly or irregularly. Namely, the wearable device may automatically transmit the current state data of a user to the mobile device at a fixed interval, or the wearable device may irregularly receive a data transmission command from the user and may manually transmit the current vital sign data of a user to the mobile device.

A wearable device may be, for example, either: a smart watch, a smart ring, smart glasses, smart shoes, or smart clothing. Since a user can wear a smart watch or a smart ring all day long, and does not need to take it off even during sleep, these two wearable devices are particularly advantageous. A smart wearable device may, for example, collect vital sign parameters of the user in real time, and the mobile device may determine to switch operation mode based on the data collected by the smart wearable device. The switch of operation modes of the mobile device not only can meet the requirement of the user on the ring volume, but also can meet the requirement of power saving levels.

As a specific application example: a user may enter a rest state or may wake up from the rest state. A smart watch may receive a connection establishing command from the user before the user rests, and may establish connection with a smart phone (block 101). The smart watch may acquire vital sign parameters of the user during the rest with a variety of sensors provided in, for example, the smart watch (block 102). The smart watch may transmit the collected vital sign parameter data of the user to the smart phone (block 103). Based on the received vital sign parameters of the user, and with reference to the vital sign parameters, e.g., a current state of the user stored in the smart phone, the smart phone may determine whether the user is currently in the sleep state (block 104). When the smart phone determines that the user is in a sleep state (block 104), a mode of the smart phone may be, for example, adjusted to a silent mode, and at the same time, some applications and functions of the smart phone may be restricted (block 105). When the smart phone determines that the user enters a normal state, the mode of the smart phone may be, for example, adjusted to a normal mode, and at the same time, any associated restrictions on applications and/or functions may be lifted (block 106). Thereby, the smart phone may automatically meet a user's daily life requirements by switching operation modes of the mobile device, through the data exchange between the wearable device and the mobile device, which makes it more convenient for the user to use and control the device.

Based on the above method, a system for controlling operation modes of a mobile device, as shown in FIG. 2, may include a monitoring and transmitting module 210 for a wearable device to acquire current vital sign data of a user and to transmit the current vital sign data to a mobile device. The system may also include a receiving and determining module 220 for the mobile device to receive the vital sign data and to determine a current motion state of a user according to the vital sign data. The system may further include a mode switching module 230 for the mobile device to acquire an operation mode corresponding to a current motion state of the user according to the current motion state of the user, and to switch a current operation mode of the mobile device to the corresponding operation mode.

With further reference to FIG. 2, the system for controlling operation modes of a mobile device may include a setting module 200 for the mobile device to receive an operation command from the user and to set operation modes corresponding to a plurality of respective motion states of the user.

The monitoring and transmitting module 210 may, for example, include a connection unit for the wearable device to receive an operation command from the user and to establish connection with the mobile device. The monitoring and transmitting module 210 may also include a state acquiring unit for the wearable device to acquire current vital sign data of the user with a sensor provided therein. The monitoring and transmitting module 210 may further include a transmitting unit for the wearable device to receive an operation command from the user and to transmit the vital sign data to a mobile device. The wearable device may be either: a smart watch, a smart ring, smart glasses, smart shoes or smart clothing.

In summary, a method and a system for controlling operation modes of a mobile device may include a wearable device that acquires current vital sign data of a user, and may transmit the current vital sign data to a mobile device. The mobile device may receive the vital sign data and may determines a current motion state of the user according to the vital sign data. The mobile device may acquire an operation mode corresponding to a current motion state of the user according to the current motion state of the user, and may switch a current operation mode of the mobile device to the corresponding operation mode. With the wearable device or accessories thereof, a state of a user may be automatically determined intelligently, and a smart terminal may be controlled to enter a corresponding operation mode. The wearable device may achieve a function of intelligently controlling an operation mode switch similar to, for example, remote control, making it more convenient for the user to use the device.

It should be understood that applications of the present invention are not limited to the above examples. To those skilled in the art, improvements or modifications may be made according to the above description, and all of these improvements or modifications shall be encompassed by the appended claims.

1. A method for controlling operation modes of a mobile device, the method comprising comprises steps of:
a wearable device acquires current vital sign data of a user, and transmits the current vital sign data to the mobile device;
the mobile device receives the vital sign data and determines a current motion state of the user according to the vital sign data;
the mobile device acquires an operation mode corresponding to the current motion state of the user according to the current motion state of the user, and switches a current operation mode of the mobile device to the corresponding operation mode.

2. The method for controlling operation modes of a mobile device according to claim 1, further comprising:
the mobile device receives an operation command from the user and sets operation modes corresponding to a plurality of respective motion states of the user.

3. The method for controlling operation modes of a mobile device according to claim 1, wherein:
the wearable device receives an operation command from the user and establishes connection with the mobile device;
the wearable device acquires current vital sign data of the user with a sensor provided therein;
the wearable device receives an operation command from the user and transmits the vital sign data to the mobile device.

4. The method for controlling operation modes of a mobile device according to claim 1, wherein operation modes of the mobile device comprise a power saving mode, a silent mode and a normal mode.

5. The method for controlling operation modes of a mobile device according to claim 1, wherein the wearable device establishes connection with the mobile device via any one of Bluetooth, IR, wifi and NFC.

6. The method for controlling operation modes of a mobile device according to claim 1, wherein the wearable device is either a smart watch, a smart ring, smart glasses, smart shoes or smart clothing.

7. A method for controlling operation modes of a mobile device, the method comprising:
the mobile device receives an operation command from the user and sets operation modes corresponding to a plurality of respective motion states of the user;
a wearable device acquires current vital sign data of a user, and transmits the current vital sign data to the mobile device;
the wearable device receives an operation command from the user and establishes connection with the mobile device;
the wearable device acquires current vital sign data of the user with a sensor provided therein;
the wearable device receives an operation command from the user and transmits the vital sign data to a mobile device;
the mobile device receives the vital sign data and determines a current motion state of the user according to the vital sign data;
the mobile device acquires an operation mode corresponding to the current motion state of the user according to the current motion state of the user, and switches a current operation mode of the mobile device to the corresponding operation mode.

8. The method for controlling operation modes of a mobile device according to claim 7, wherein the vital sign data includes a variety of data of the human body collected via a variety of sensors, including at least one of: using a variety of sensors to recognize and record active time and rest time, exercise intensity, a number of steps, walking distance and calories burned by a user in an exercise state; recognizing and recording slight wrist movements in states of light sleep and deep sleep, recording time needed to fall asleep, balance between light sleep and deep sleep, time lying on a bed and times of wake-up during a night.

9. The method for controlling operation modes of a mobile device according to claim 7, wherein operation modes of the mobile device comprise a power saving mode, a silent mode and a normal mode.

10. The method for controlling operation modes of a mobile device according to claim 7, wherein the wearable device establishes connection with the mobile device via any one of Bluetooth, IR, wifi and NFC.

11. The method for controlling operation modes of a mobile device according to claim 7, wherein the wearable device is either a smart watch, a smart ring, smart glasses, smart shoes or smart clothing.

12. The method for controlling operation modes of a mobile device according to claim 1, wherein
the vital sign data includes a variety of data of the human body collected via a variety of sensors, including at least one of: using a variety of sensors to recognize and record active time and rest time, exercise intensity, a number of steps, walking distance and calories burned by a user in an exercise state; recognizing and recording slight wrist movements in states of light sleep and deep sleep, recording time needed to fall asleep, balance between light sleep and deep sleep, time lying on a bed and times of wake-up during a night.

13. The method for controlling operation modes of a mobile device according to claim 12, wherein:
the wearable device receives an operation command from the user and establishes connection with the mobile device;
the wearable device acquires current vital sign data of the user with a sensor provided therein;
the wearable device receives an operation command from the user and transmits the vital sign data to the mobile device.

14. A system for controlling operation modes of a mobile device, the system comprising:
a monitoring and transmitting module for a wearable device to acquire current vital sign data of a user and to transmit the current vital sign data to the mobile device;
a receiving and determining module for the mobile device to receive the vital sign data and to determine a current motion state of the user according to the vital sign data;
a mode switching module for the mobile device to acquire an operation mode corresponding to a current motion state of the user according to the current motion state of the user, and to switch a current operation mode of the mobile device to the corresponding operation mode.

15. The system for controlling operation modes of a mobile device according to claim 14, further comprising:
a setting module for the mobile device to receive an operation command from the user and to set operation modes corresponding to a plurality of respective motion states of the user.

16. The system for controlling operation modes of a mobile device according to claim 14, wherein the transmitting module comprises:
a connection unit for the wearable device to receive an operation command from the user and to establish connection with the mobile device;
a state acquiring unit for the wearable device to acquire current vital sign data of the user with a sensor provided therein;
a transmitting unit for the wearable device to receive an operation command from the user and to transmit the vital sign data to the mobile device.

17. The system for controlling operation modes of a mobile device according to claim 14, wherein the wearable device is either a smart watch, a smart ring, smart glasses, smart shoes or smart clothing.

18. The system for controlling operation modes of a mobile device according to claim 14, wherein operation modes of the mobile device comprise a power saving mode, a silent mode and a normal mode.

19. The system for controlling operation modes of a mobile device according to claim 14, wherein the vital sign data includes a variety of data of the human body collected via a variety of sensors, including at least one of: using a variety of sensors to recognize and record active time and rest time, exercise intensity, a number of steps, walking distance and calories burned by a user in an exercise state; recognizing and recording slight wrist movements in states of light sleep and deep sleep, recording time needed to fall asleep, balance between light sleep and deep sleep, time lying on a bed and times of wake-up during a night.

20. The system for controlling operation modes of a mobile device according to claim 7, wherein the wearable device establishes connection with the mobile device via any one of Bluetooth, IR, wifi and NFC.
